(19) United States
(12) Patent Application Publication
(10) Pub. No.: US 2003/0098965 A1
(43) Pub. Date: May 29, 2003

(54) System and method for supporting a device holder with separate components

(76) Inventors: Mike Binnard, Belmont, CA (US); Mats Engwall, San Juan Bautista, CA (US)

Correspondence Address: The Law Office of Steven G. Roeder, 5560 Chelsea Avenue, LaJolla, CA, 92037, US

(21) Appl. No.: 10/288,075

(22) Filed: Nov. 4, 2002

Related U.S. Application Data
(63) Continuation-in-part of application No. 09/997,553, filed on Nov. 29, 2001.

(51) Int. Cl. G03B 27/60

(52) U.S. Cl. 355/73; 355/72; 355/75; 355/53; 310/10; 378/34

(57) ABSTRACT

A stage assembly (224) for moving and positioning a device (300) includes a device table (308), a device holder (312) that retains the device (300), and a holder connector assembly (338). The holder connector assembly (338) includes a first assembly (320) that supports the device holder (312) relative to the device table (308) along a first axis, and a second assembly (322) that supports the device holder (312) relative to the device table (308) along a second axis, the second axis being orthogonal to the first axis.

### RELATED APPLICATION

The present invention is a continuation-in-part of U.S. application Ser. No. 09/997,553, filed on Nov. 29, 2001, and entitled “System and method for holding a device with minimal deformation.” As far as permitted, the contents of U.S. application Ser. No. 09/997,553 are incorporated herein by reference.

### FIELD OF THE INVENTION

The present invention is directed to a stage assembly for moving and positioning a device. More specifically, the present invention is directed to a system and method for supporting a device holder that retains a semiconductor wafer for an exposure apparatus.

### BACKGROUND

Exposure apparatuses are commonly used to transfer images from a reticle onto a semiconductor wafer during semiconductor processing. A typical exposure apparatus includes an illumination source, a reticle stage assembly that retains a reticle, an optical assembly, a wafer stage assembly that retains a semiconductor wafer, and a measurement system. The semiconductor wafer includes a plurality of chip alignment marks that identify the location of the chips on the semiconductor wafer.

The wafer stage assembly can include a wafer stage base, a wafer stage including a wafer holder that retains the wafer, and a wafer mover assembly that precisely positions the wafer stage and the wafer. Somewhat similarly, the reticle stage assembly includes a reticle stage base, a reticle stage that retains the reticle, and a reticle mover assembly that precisely positions the reticle stage and the reticle. In order to obtain precise relative positioning, the position of the reticle stage and the wafer stage are constantly monitored by the measurement system. With this information, the wafer mover assembly precisely positions the wafer and the reticle mover assembly precisely positions the reticle.

The wafer mover assembly moves the wafer stage and the wafer between an alignment position and an operational position. In the alignment position, the wafer is loaded onto the wafer stage. Subsequently, in the alignment position, an alignment device, e.g. a microscope, is used to align and determine the position of the chip alignment marks of the wafer relative to the wafer stage and the measurement system. In the operational position, a projection device, e.g. a projection microscope, is used to check alignment of the wafer relative to the reticle through the optical assembly of the exposure apparatus. Finally, in the operational position, images from the reticle are transferred to the wafer.

The size of the images and features within the images transferred onto the wafer from the reticle are extremely small. Accordingly, the precise positioning of the wafer and the reticle relative to the optical device is critical to the manufacture of high density, semiconductor wafers.

One way to improve the accuracy of the exposure apparatus includes improving the determination of the location of the chip alignment marks relative to the wafer stage and the measurement system. For example, the alignment and determination of the chip alignment marks can be improved by (i) initially aligning and determining the position of the chip alignment marks in a first position with the alignment device, and (ii) subsequently, rotating the wafer 180 degrees to a rotated second position, and (iii) aligning and determining the position of the chip alignment marks in the second position with the alignment device. With this information, the errors in the alignment device can be averaged. Next, the wafer is rotated back to the first position and then the wafer is moved to the operational area.

Unfortunately, rotation of the wafer between the positions can deform the wafer. The deformation of the wafer compromises the accuracy of the alignment process. Ultimately, this reduces the accuracy of positioning of the wafer relative to the reticle and degrades the accuracy of the exposure apparatus.

In light of the above, there is a need for a stage assembly and method for precisely positioning a device. Further, there is a need for an exposure apparatus that allows for more accurate positioning of the semiconductor wafer relative to the reticle. Furthermore, there is a need for an exposure apparatus capable of manufacturing precision devices such as high density, semiconductor wafers.

### SUMMARY

The present invention is directed to a stage assembly for positioning a device. The stage assembly includes a device table, a device holder that retains the device, and a holder connector assembly. The holder connector assembly flexibly connects the device holder to the device table. In one embodiment, the holder connector assembly includes a first assembly and a second assembly. The first assembly supports the device holder along a first axis while the second assembly supports the device holder along a second axis that is orthogonal to the first axis.

As provided herein, the characteristics of the first assembly can be different from the characteristics of the second assembly to achieve the desired stiffness and size characteristics of the holder connector assembly. For example, the stiffness of the first assembly can be greater than the stiffness of the second assembly.

In one embodiment, the first assembly also supports the device holder along a third axis that is substantially orthogonal to the first axis and the second axis. Further, the first assembly can support the device holder about the second axis. In this design, the first assembly supports the device holder in the horizontal degrees of freedom. Additionally, the second assembly can support the device holder about the first axis and about the third axis. In this design, the second assembly supports the device holder in the vertical degrees of freedom.

In some of the embodiments, the holder connector kinematically supports the device holder. For example, the first assembly can include three spaced apart flexures that cooperate to kinematically support the device holder along the first axis and the third axis. Further, the second assembly can include three spaced apart flexures that cooperate to kinematically support the device holder along the second axis. Alternately, the second assembly can include three spaced apart fluid bearings that cooperate to support the device holder.

Additionally, the stage assembly can include a carrier. In this embodiment, the carrier is rotatably secured to the device table, and the holder connector assembly flexibly connects the device holder to the carrier so that rotation of the carrier results in rotation of the device holder. With this design, for example, all of the clamping, rotating, loading/unloading and bearing forces can be applied to the carrier to move the carrier and the device holder without distorting and deforming the device holder and influencing the flatness of the device.

The present invention is also directed to an exposure apparatus, a device, a semiconductor wafer, a method for making a stage assembly, a method for making an exposure apparatus, a method for making a device, and a method for making a wafer.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a side illustration of an exposure assembly having features of the present invention;

FIG. 2 is a perspective view of a stage assembly having features of the present invention;

FIG. 3A is a side view of one embodiment of a table assembly having features of the present invention;

FIG. 3B is a top, exploded perspective view of the table assembly of FIG. 3A;

FIG. 3C is a perspective view of a first flexure having features of the present invention;

FIG. 4 is a perspective view of another embodiment of a second flexure having features of the present invention;

FIG. 5 is a perspective view of another embodiment of a second flexure having features of the present invention;

FIG. 6 is a perspective view of another embodiment of a table assembly having features of the present invention;

FIG. 7A is a flow chart that outlines a process for manufacturing a device in accordance with the present invention; and

FIG. 7B is a flow chart that outlines device processing in more detail.

### DESCRIPTION

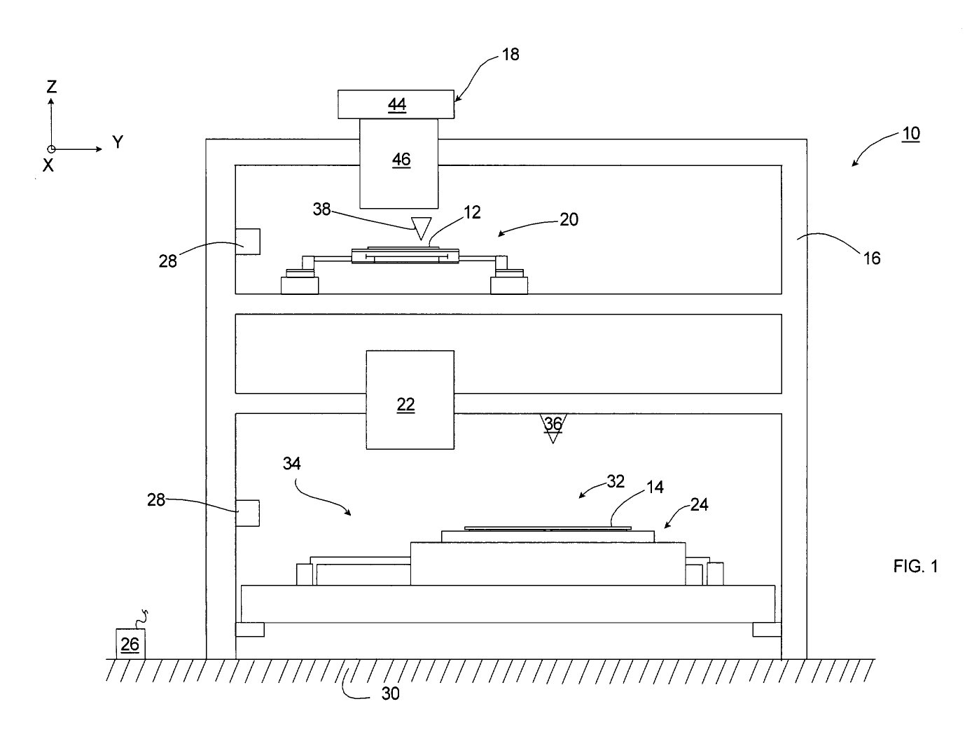

FIG. 1 is a schematic view that illustrates a precision assembly, namely an exposure apparatus 10. The exposure apparatus 10 is particularly useful as a lithographic device that transfers a pattern (not shown) of an integrated circuit from a reticle 12 onto a device, such as a semiconductor wafer 14. In FIG. 1, the exposure apparatus 10 includes an apparatus frame 16, an illumination system 18 (irradiation apparatus), a reticle stage assembly 20, an optical assembly 22 (lens assembly), a wafer stage assembly 24, a control system 26, and a measurement system 28. The exposure apparatus 10 mounts to a mounting base 30, e.g., the ground, a base, or floor or some other supporting structure. The design of the components of the exposure apparatus 10 can be varied to suit the design requirements of the exposure apparatus 10.

As an overview, the wafer stage assembly 24 can move the wafer 14 between an alignment position 32 and an operational position 34. Typically, the wafer 14 includes a plurality of chip alignment marks (not shown) that identify the location of the chips (not shown) on the wafer 14. In the alignment position 32, an alignment device 36, e.g. a microscope, is used to align and determine the position of the wafer alignment marks of the wafer 14 relative to the measurement system 28. During this time, the wafer stage assembly 24 moves the wafer 14 relatively slowly. In the operational position 34, a projection device 38, e.g. a projection microscope, is used to check alignment of the wafer 14 relative to the reticle 12 through the optical assembly 22. Subsequently, in the operational position 34, images from the reticle 12 are transferred to the wafer 14. During image transfer, the wafer stage assembly 24 moves the wafer 14 with rapid accelerations.

As provided herein, in some embodiments, the wafer stage assembly 24 accurately rotates the wafer 14 between a first position, a second position and back to the first position. In these embodiments, the wafer stage assembly 24 includes one or more features that allow wafer 14 to be precisely rotated between the positions and/or moved without influencing the flatness of the wafer 14 and without deflecting and distorting the wafer 14. Stated another way, with the present design, the wafer 14 can be brought back to the same place and the flatness of the wafer 14 is not significantly influenced.

Typically, in the second position, the wafer 14 is rotated 180 degrees relative to the first position. In some embodiments, the wafer 14 can be rotated (i) at least approximately 5 degrees; (ii) at least approximately 25 degrees, (iii) at least approximately 50 degrees, (iv) at least approximately 90 degrees, (v) at least approximately 120 degrees, (vi) at least approximately 180 degrees, and/or (vii) at least approximately 360 degrees.

The alignment device 36 can be used to align and determine the position of the wafer alignment marks of the wafer 14 relative to the measurement system 28 when the wafer 14 is in the first position and subsequently when the wafer 14 is in the second position. As a result thereof, the errors in the alignment device 36 can be averaged. This improves the positioning performance of the exposure apparatus 10. Further, for an exposure apparatus 10, this allows for the manufacturing of higher density, semiconductor wafers 14.

A number of Figures include a coordinate system that illustrates an X axis, a Y axis that is orthogonal to the X axis and a Z axis that is orthogonal to a X and Y axes. It should be noted that the coordinate system can be rotated and/or that these axes can also be referred to as the first, second and third axes.

There are a number of different types of lithographic devices. For example, the exposure apparatus 10 can be used as scanning type photolithography system that exposes the pattern from the reticle 12 onto the wafer 14 with the reticle 12 and the wafer 14 moving synchronously. In a scanning type lithographic device, the reticle 12 is moved perpendicular to an optical axis of the optical assembly 22 by the reticle stage assembly 20 and the wafer 14 is moved perpendicular to the optical axis of the optical assembly 22 by the wafer stage assembly 24. Scanning of the reticle 12 and the wafer 14 occurs while the reticle 12 and the wafer 14 are moving synchronously.

Alternately, the exposure apparatus 10 can be a step-and-repeat type photolithography system that exposes the reticle 12 while the reticle 12 and the wafer 14 are stationary. In the step and repeat process, the wafer 14 is in a constant position relative to the reticle 12 and the optical assembly 22 during the exposure of an individual field. Subsequently, between consecutive exposure steps, the wafer 14 is consecutively moved with the wafer stage assembly 24 perpendicular to the optical axis of the optical assembly 22 so that the next field of the wafer 14 is brought into position relative to the optical assembly 22 and the reticle 12 for exposure. Following this process, the images on the reticle 12 are sequentially exposed onto the fields of the wafer 14 and the next field of the wafer 14 is brought into position relative to the optical assembly 22 and the reticle 12.

However, the use of the exposure apparatus 10 provided herein is not limited to a photolithography system for semiconductor manufacturing. The exposure apparatus 10, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly.

The apparatus frame 16 is rigid and supports the components of the exposure apparatus 10. The apparatus frame 16 illustrated in FIG. 1 supports the optical assembly 22, the illumination system 18, and the stage assemblies 20, 24 above the mounting base 30.

The illumination system 18 includes an illumination source 44 and an illumination optical assembly 46. The illumination source 44 emits a beam (irradiation) of light energy. The illumination optical assembly 46 guides the beam of light energy from the illumination source 44 to the optical assembly 22. The beam selectively illuminates different portions of the reticle 12 and exposes the semiconductor wafer 14. In FIG. 1, the illumination source 44 is illustrated as being supported above the reticle stage assembly 20. Typically, however, the illumination source 44 is secured to one of the sides of the apparatus frame 16 and the energy beam from the illumination source 44 is directed to above the reticle stage assembly 20 with the illumination optical assembly 46.

The illumination source 44 can be g-line (436 nm), i-line (365 nm), KrF excimer laser (248 nm), ArF excimer laser (193 nm) and F₂ laser (157 nm). Alternately, the illumination source 44 can also use charged particle beams such as an x-ray and electron beam. For instance, in the case where an electron beam is used, thermionic emission type lanthanum hexaboride (LaB₆) or tantalum (Ta) can be used as an electron gun. Furthermore, in the case where an electron beam is used, the structure could be such that either a mask is used or a pattern can be directly formed on a substrate without the use of a mask.

The optical assembly 22 projects and/or focuses the light passing through the reticle 12 to the wafer 14. Depending upon the design of the exposure apparatus 10, the optical assembly 22 can magnify or reduce the image illuminated on the reticle 12. The optical assembly 22 need not be limited to a reduction system. It could also be a lx or magnification system.

When far ultra-violet rays such as the excimer laser is used, glass materials such as quartz and fluorite that transmit far ultra-violet rays is preferable to be used in the optical assembly 22. When the F₂ type laser or x-ray is used, the optical assembly 22 should preferably be either catadioptric or refractive (a reticle should also preferably be a reflective type), and when an electron beam is used, electron optics should preferably consist of electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No.8-171054 published in the Official Gazette for Laid-Open Patent Applications and its counterpart U.S. Pat. No. 5,668,672, as well as Japan Patent Application Disclosure No.10-20195 and its counterpart U.S. Pat. No. 5,835,275. In these cases, the reflecting optical device can be a catadioptric optical system incorporating a beam splitter and concave mirror. Japan Patent Application Disclosure No.8-334695 published in the Official Gazette for Laid-Open Patent Applications and its counterpart U.S. Pat. No. 5,689,377 as well as Japan Patent Application Disclosure No.10-3039 and its counterpart U.S. Patent Application No. 873,605 (Application Date: Jun. 12, 1997) also use a reflecting-refracting type of optical system incorporating a concave mirror, etc., but without a beam splitter, and can also be employed with this invention. As far as is permitted, the disclosures in the above-mentioned U.S. patents, as well as the Japan patent applications published in the Official Gazette for Laid-Open Patent Applications are incorporated herein by reference.

The reticle stage assembly 20 holds and positions the reticle 12 relative to the optical assembly 22 and the wafer 14. Similarly, the wafer stage assembly 24 holds and positions the wafer 14 with respect to the projected image of the illuminated portions of the reticle 12 in the operational position 34. The wafer stage assembly 24 is described in more detail below.

Further, in photolithography systems, when linear motors (see U.S. Pat. Nos. 5,623,853 or 5,528,118) are used in a wafer stage or a mask stage, the linear motors can be either an air levitation type employing air bearings or a magnetic levitation type using Lorentz force or reactance force. Additionally, the stage could move along a guide, or it could be a guideless type stage that uses no guide. As far as is permitted, the disclosures in U.S. Pat. Nos. 5,623,853 and 5,528,118 are incorporated herein by reference.

Alternatively, one of the stages could be driven by a planar motor, which drives the stage by an electromagnetic force generated by a magnet unit having two-dimensionally arranged magnets and an armature coil unit having two-dimensionally arranged coils in facing positions. With this type of driving system, either the magnet unit or the armature coil unit is connected to the stage and the other unit is mounted on the moving plane side of the stage.

Movement of the stages as described above generates reaction forces that can affect performance of the photolithography system. Reaction forces generated by the wafer (substrate) stage motion can be mechanically released to the floor (ground) by use of a frame member as described in U.S. Pat. No. 5,528,100 and published Japanese Patent Application Disclosure No. 8-136475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. As far as is permitted, the disclosures in U.S. Pat. Nos. 5,528,100 and 5,874,820 and Japanese Patent Application Disclosure No. 8-330224 are incorporated herein by reference.

The control system 26 receives information from the measurement system 28 and controls the stage mover assemblies 20, 24 to precisely position the reticle 12 and the wafer 14.

The measurement system 28 monitors movement of the reticle 12 and the wafer 14 relative to the optical assembly 22 or some other reference. With this information, the control system 26 can control the reticle stage assembly 20 to precisely position the reticle 12 and the wafer stage assembly 24 to precisely position the wafer 14. For example, the measurement system 28 can utilize multiple laser interferometers, encoders, and/or other measuring devices.

A photolithography system (an exposure apparatus) according to the embodiments described herein can be built by assembling various subsystems, including each element listed in the appended claims, in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

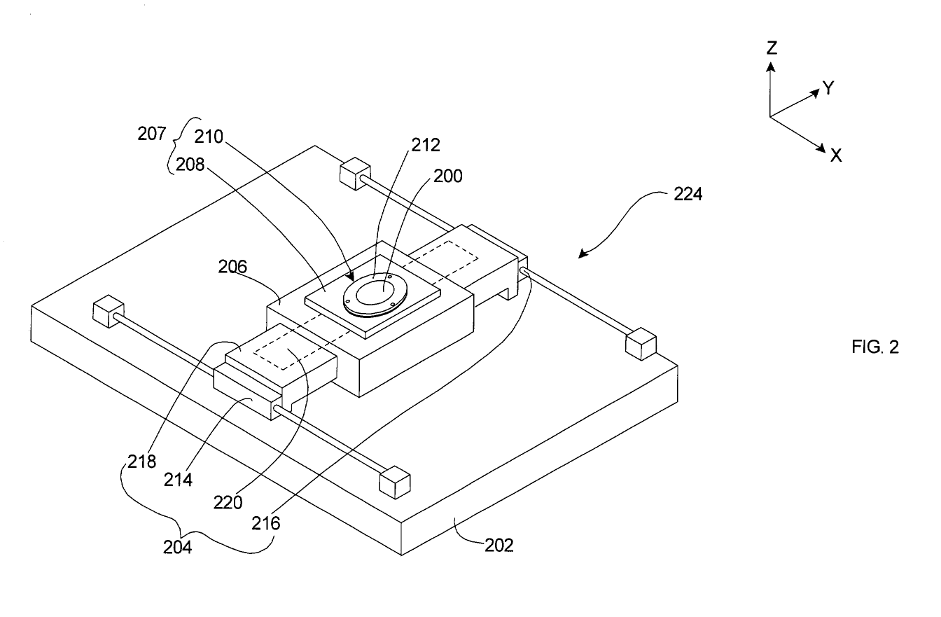

FIG. 2 is a perspective view of a stage assembly 224 that is used to position a device 200. For example, the stage assembly 224 can be used to position a wafer during manufacturing of the semiconductor wafer. Alternately, the stage assembly 224 can be used to move other types of devices 200 during manufacturing and/or inspection, to move a device under an electron microscope (not shown), or to move a device during a precision measurement operation (not shown). For example, the features of the stage assembly 224 illustrated in FIG. 2 can be incorporated into a reticle stage assembly.

The stage assembly 224 includes a stage base 202, a stage mover assembly 204, a stage 206, and a table assembly 207. The table assembly 207 includes a device table 208, and a holder assembly 210 including a device holder 212. In the embodiment illustrated in FIG. 2, the device table 208 is moved by the stage mover assembly 204 relative to the stage base 202 along the X axis, along the Y axis, and about the Z axis (collectively “the horizontal degrees of freedom”). Additionally, the stage mover assembly 204 could be designed to move and position the device table 208 along the Z axis, about the X axis and about the Y axis relative to the stage base 202. Alternately, for example, the stage mover assembly 204 could be designed to move the device table 208 with less than three degrees of freedom.

The design of the components of the stage assembly 224 can be varied to suit design requirements. For example, in FIG. 2, the stage assembly 224 includes one device table 208. Alternately, however, the stage assembly 224 could be designed to include more than one device table 208.

The stage base 202 supports some of the components of the stage assembly 224 above the mounting base 30 (illustrated in FIG. 1). In FIG. 2, the stage base 202 is generally rectangular shaped.

The stage mover assembly 204 controls and moves the stage 206 and the table assembly 207 relative to the stage base 202. In FIG. 2, the stage mover assembly 204 includes a left X stage mover 214, a right X stage mover 216, a guide bar 218, and a Y stage mover 220 (illustrated in phantom). The X stage movers 214, 216 move the guide bar 218, the stage 206 and the table assembly 207 with a relatively large displacement along the X axis and with a limited range of motion about the Z axis, and the Y stage mover 220 moves the stage 206 and the table assembly 207 with a relatively large displacement along the Y axis relative to the guide bar 218.

The design of each stage mover 214, 216, 220 can be varied to suit the movement requirements of the stage assembly 224. For example, each of the stage movers 214, 216, 220 can include one or more rotary motors, voice coil motors, linear motors utilizing a Lorentz force to generate drive force, electromagnetic actuators, or some other force actuators. In the embodiment illustrated in FIG. 2, each of the stage movers 214, 216, 220 is a linear motor.

The guide bar 218 moves the stage 206 along the X axis and about the Z axis and guides the movement of the stage 206 along the Y axis. In FIG. 2, the guide bar 218 is somewhat rectangular beam shaped. A bearing (not shown) maintains the guide bar 218 spaced apart along the Z axis relative to the stage base 202 and allows for motion of the guide bar 218 along the X axis and about the Z axis relative to the stage base 202. The bearing can be a vacuum preload type fluid bearing that maintains the guide bar 218 spaced apart from the stage base 202 in a non-contact manner. Alternately, for example, a magnetic type bearing or a ball bearing type assembly could be utilized that allows for motion of the guide bar 218 relative to the stage base 202.

In FIG. 2, the stage 206 moves with the guide bar 218 along the X axis and about the Z axis and the stage 206 moves along the Y axis relative to the guide bar 218. In this embodiment, the stage 206 is generally rectangular shaped and includes a rectangular shaped opening for receiving the guide bar 218. A bearing (not shown) maintains the stage 206 spaced apart along the Z axis relative to the stage base 202 and allows for motion of the stage 206 along the X axis, along the Y axis and about the Z axis relative to the stage base 202. The bearing can be a vacuum preload type fluid bearing that maintains the stage 206 spaced apart from the stage base 202 in a non-contact manner. Alternately, for example, a magnetic type bearing or a ball bearing type assembly could be utilized that allows for motion of the stage 206 relative to the stage base 202.

Further, the stage 206 is maintained apart from the guide bar 218 with opposed bearings (not shown) that allow for motion of the stage 206 along the Y axis relative to the guide bar 218, while inhibiting motion of the stage 206 relative to the guide bar 218 along the X axis and about the Z axis. Each bearing can be a fluid bearing that maintains the stage 206 spaced apart from the guide bar 218 in a non-contact manner. Alternately, for example, a magnetic type bearing or a ball bearing type assembly could be utilized that allows for motion of the stage 206 relative to the guide bar 218.

In FIG. 2, the device table 208 is generally rectangular plate shaped. Further, the device table 208 is fixedly secured to the stage 206 and moves concurrently with the stage 206. Alternately, for example, the stage mover assembly 204 can include a table mover assembly (not shown) that moves and adjusts the position of the device table 208 relative to the stage 206. For example, the table mover assembly can adjust the position of the device table 208 relative to the stage 206 with six degrees of freedom. Alternately, for example, the table mover assembly can be designed to move the device table 208 relative to the stage 206 with only three degrees of freedom. The table mover assembly can include one or more rotary motors, voice coil motors, linear motors, electromagnetic actuators, or other type of actuators.

The holder assembly 210 allows for the accurate rotation and/or movement of the device holder 212 and the device 200 while minimizing deformation of the device holder 212 and the device 200.

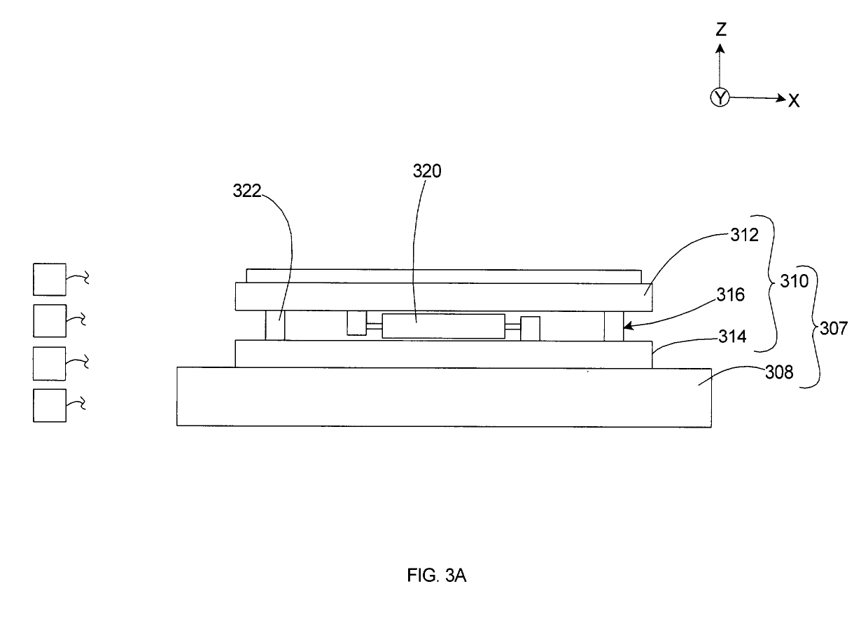

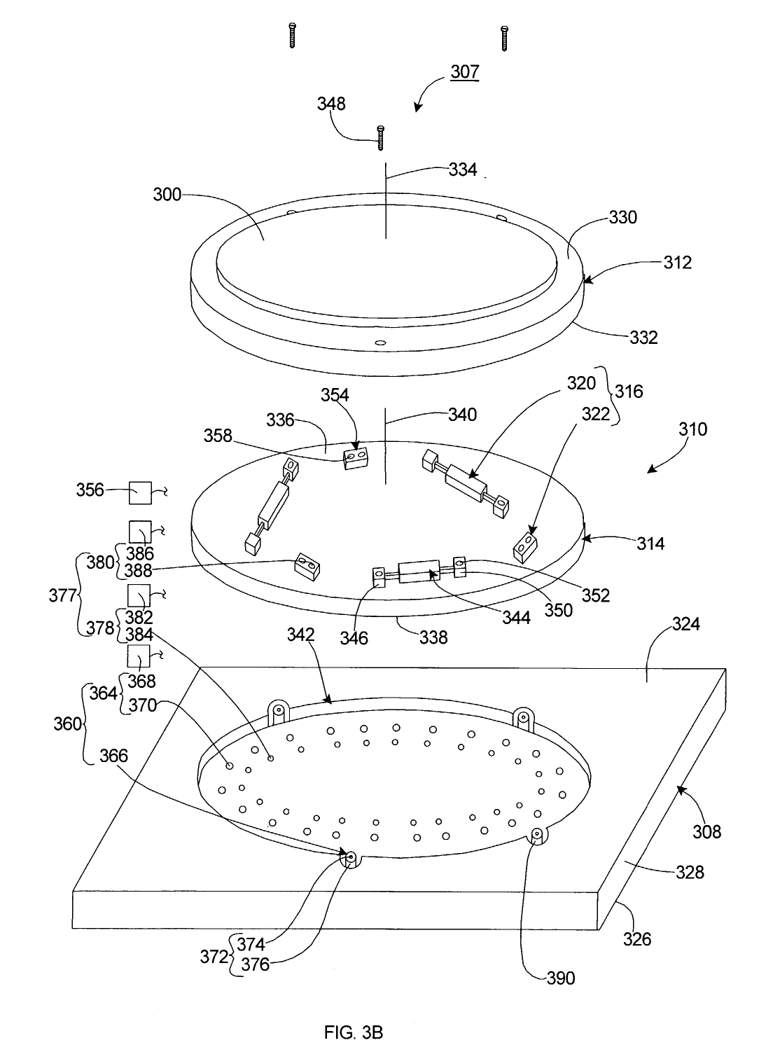

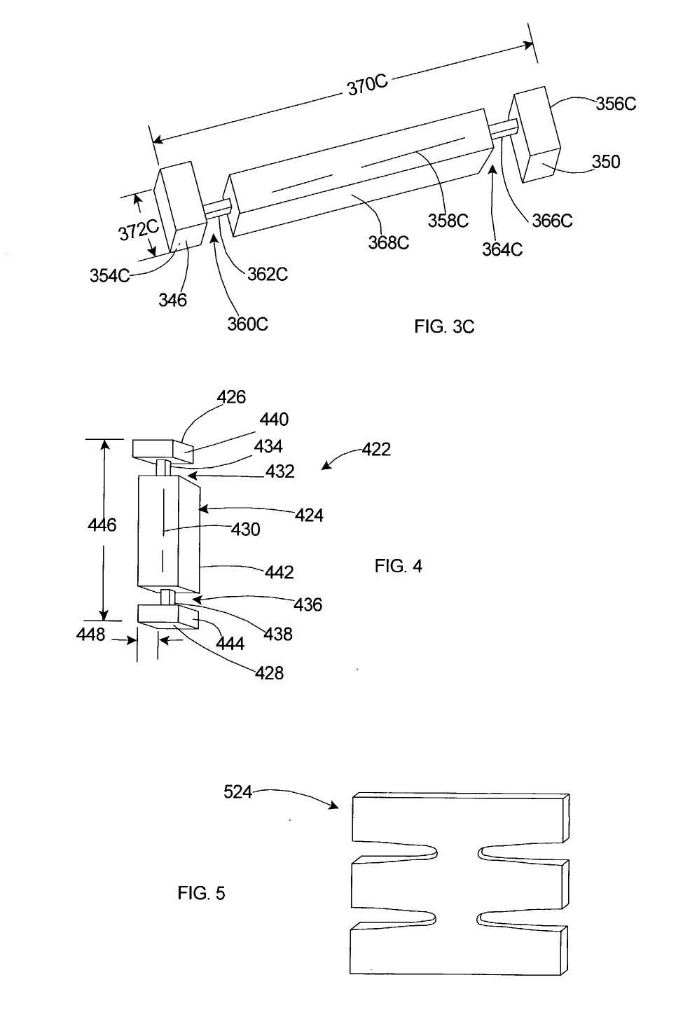

FIG. 3A illustrates a simplified side view of one embodiment of a table assembly 307 having a device table 308 and a holder assembly 310 including a device holder 312. The table assembly 307 can be used in the stage assembly 224 of FIG. 2 and the exposure apparatus 10 of FIG. 1. In this embodiment, the holder assembly 310 includes a device holder 312, a carrier 314, and a holder connector assembly 316.

In this embodiment, the holder connector assembly 316 includes (i) a first assembly 320 that supports the device holder 312 along the first axis (the X axis), along the third axis (the Y axis) and about the second axis (the Z axis), and (ii) a second assembly 322 that supports the device holder 312 along the second axis (the Z axis), about the first axis (the X axis) and about the third axis (the Y axis).

With this design, (i) the first assembly 320 can be designed and shaped to provide the desired support of the device holder 312 along the first axis, along the third axis and about the second axis and (ii) the second assembly 322 can be designed and shaped to provide the desired support of the device holder 312 along the second axis, about the first axis and about the second axis. With this design, the size and stiffness of each of the assemblies 320, 322 can be optimized.

For example, in one embodiment, to obtain good performance in the stage assembly 224 (illustrated in FIG. 2), the kinematic coupling between the device holder 312 and the device table 308 must have a high stiffness ratio along the X axis and along the Y axis, but only moderate stiffness along the Z axis is required. Using separate components for the constraints in the horizontal or vertical directions allows for the use of a bigger flexure in the horizontal direction (bigger size means a higher stiffness ratio) than in the vertical direction.

It should also be noted that in FIG. 3A, that the assemblies 320, 322 connect, couple and extend between the device holder 312 and the carrier 336.

FIG. 3B illustrates an exploded perspective view of the table assembly 307 including the device table 308, and the holder assembly 310 including the device holder 312 of FIG. 3A. In this embodiment, the device table 308 includes a table top 324, an opposed table bottom 326, and four table sides 328. The table bottom 326 is secured to the stage 206 (illustrated in FIG. 2).

The device holder 312 retains the device 300. The device holder 312 can include a vacuum chuck, an electrostatic chuck, or some other type of clamp. In the embodiment illustrated in FIG. 3B, the device holder 312 is generally disk shaped and includes a holder top 330, a holder bottom 332, and a holder central axis 334.

The carrier 314 supports the device holder 312 and facilitates rotation and/or movement of the device holder 312 and the device 300 without deforming the device holder 312 and the device 300. With this design, when the carrier 314 distorts, the device holder 312 moves, but because of the holder connector assembly 316, the device holder 312 does not significantly deform. As a result thereof, the device holder 312 can be rotated and/or moved without significantly deforming the device holder 312.

In FIG. 3B, the carrier 314 is somewhat concentric with the device holder 312 and is positioned somewhat between the device table 308 and the device holder 312. Further, the carrier 314 is generally disk shaped and includes a carrier top 336, a carrier bottom 338 and a carrier central axis 340.

Additionally, the table assembly 307 can include a carrier recess 342 for receiving at least a portion of the carrier 314. The carrier recess 342 allows for the use of the carrier 314 in the table assembly 307 without significantly increasing the footprint of the table assembly 307 over table assemblies that do not include the carrier 314. The size and shape of the carrier recess 342 can be varied. As provided herein, the carrier recess 342 can be in the table top 324 of the device table 308. In FIG. 3A, the carrier recess 342 is a disk shaped channel in the table top 324.

The holder connector assembly 316 mechanically and flexibly connects the device holder 312 to the carrier 314. As a result thereof, movement of the carrier 314 results in movement of the device holder 312. The design of the holder connector assembly 316 can be varied. In FIG. 3B, the holder connector assembly 316 substantially kinematically connects the device holder 312 to the carrier 314. With this design, deformation of the carrier 314 does not result in deformation of the device holder 312 or the device 300. Alternately, for example, the holder connector assembly 316 can connect the device holder 312 to the carrier 314 in a flexible, non-kinematic manner.

In FIG. 3B, the holder connector assembly 316 includes the first assembly 320 and the second assembly 322. In this embodiment, (i) the first assembly 320 supports the device holder 312 along the first axis, along the third axis, and about the second axis, and (ii) the second assembly 322 supports the device holder 312 along the second axis, about the first axis and about the third axis. Each assembly 320, 322 can be designed to achieve the desired characteristics, such as rigidity. For example, the characteristics of the first assembly 320 can be different than the characteristics of the second assembly 322. As an example, the stiffness of the first assembly 320 can be different than the stiffness of the second assembly 322. For example, the stiffness of the first assembly 320 can be at least approximately 50, 60, 70, 80, 90, 110, 120, 130, 150, 160, 200, 250, 300 percent of the stiffness of the second assembly 322. Stated another way, the stiffness of the first assembly 320 is at least approximately 2, 3, 4, 5, or 10 greater than the stiffness of the second assembly 322.

In FIG. 3B, the first assembly 320 includes three spaced apart first flexures 344 that extend between the device holder 312 and the carrier 314. Each first flexure 344 supports the device holder 312 relative to the carrier 314 with one degree of freedom. Stated another way, each first flexure 314 is relatively stiff in one degree of freedom, and flexible in the other five degrees of freedom. Further, the first flexures 320 are at an angle of approximately 120 degrees relative to each other. With this design, the first flexures 344 cooperate to support the device holder 312 along the first axis, along the third axis, and about the second axis. In FIG. 3B, each first flexure 344 includes (i) a first stiff section 346 that is secured to the device holder 312 with a first fastener 348 that extends through a holder aperture in the device holder 312, and (ii) a spaced second stiff section 350 that is secured to the carrier 314 with a second fastener 352. Alternately, the first stiff section 346 can be secured to the device holder 312 and the second stiff section 350 can be secured to the carrier 314 in another fashion, such as an adhesive or a weld.

In FIG. 3B, the second assembly 322 includes three spaced apart fluid pads 354 and a bearing fluid source 356 that cooperate to form three spaced apart fluid bearings that support the device holder 312 along the Z axis, about the X axis and about the Y axis relative to the carrier 314. In this embodiment, each fluid pad 354 is generally rectangular shaped and is fixedly secured to the carrier 314. Further, each fluid pad 354 includes one or more fluid outlets 358. The fluid source 356 provides pressurized fluid, e.g. air, to the fluid outlets 358. When fluid is released from the fluid outlets 358, a fluid bearing is created that lifts and supports the device holder 312. Alternately, the fluid pads 354 could be secured to the device holder 312 and the fluid outlets 358 can be directed towards the carrier 314.

It should be noted that in the embodiment of FIG. 3B, the stiffness of the second assembly 322 can be varied by adjusting the fluid pressure. Further, each fluid pad 354 can also include one or more fluid inlets 388. In this design, a vacuum source 386 can be connected to the fluid inlets to create a vacuum preload type, fluid bearing between the device holder 312 and the carrier 314. The vacuum preload type fluid bearings maintain the device holder 312 spaced apart from the carrier 314.

Additionally, the holder assembly 310 can include a rotation assembly 360 that allows for the rotation of the device 300 relative to the device table 308. In FIG. 3B, the rotation assembly 360 allows for the rotation of the carrier 314 about the carrier central axis 340. Further, in this embodiment, (i) the holder central axis 334, the carrier central axis 340 and the holder axis of rotation are coaxial, (ii) the device holder 312 rotates about the holder central axis 334 and (iii) the carrier 314 rotates about the carrier central axis 340. The design of the rotation assembly 360 can be varied. In FIG. 3B, the rotation assembly 360 includes a lifting bearing assembly 364 and a guiding bearing assembly 366.

The lifting bearing assembly 364 selectively lifts the carrier 314 away from the device table 308. In this embodiment, the lifting bearing assembly 364 includes a bearing fluid source 368 and one or more fluid outlets 370. The fluid source 368 provides pressurized fluid, e.g. air, to the fluid outlets 370. When fluid is released from the fluid outlets 370, a fluid bearing is created that lifts the carrier 314 and allows for rotation of the carrier 314 and the device holder 312 about the Z axis relative to the device table 308. The fluid outlets 370 can be in the device table 308 and directed towards the carrier 314 and/or in the carrier 314 and directed towards the device table 308. In FIG. 3A, the fluid outlets 370 are in the carrier recess 342 of the device table 308.

The guiding bearing assembly 366 guides the rotation of the carrier 314 relative to the device table 308. In this embodiment, the guiding bearing assembly 366 includes three spaced apart mechanical roller type bearing assemblies 372. Each roller type bearing assembly 372 includes a bearing shaft 374 that is secured to the device table 308 and a roller bearing 376 that is secured to the bearing shaft 374. An outer race of the roller bearing 376 rotates relative to the bearing shaft 374. In FIG. 3B, the outer race engages the outer diameter surface of the carrier 314. With this design, the roller bearing assemblies 372 cooperate to guide the rotation of the carrier 314. It should be noted that one of the shafts 374 is secured to the device table 308 in a manner that allows the shaft 374 to move slightly relative to the device table 308. This feature allows the roller bearing assemblies 372 to accommodate inaccuracies in the shape of the carrier 314.

Alternately, for example, the guide bearing assembly could be a fluid type bearing that supports the carrier 314 relative to the device table 308 in a non-contact fashion. Alternately, for example, the rotation assembly 360 can include a magnetic type bearing or other type of bearings that allows for motion of the carrier 314 relative to the device table 308.

Additionally, the table assembly 307 can include a lock assembly 377 that selectively locks the device holder 312 to the device table 312. The design of the lock assembly 377 can vary. In FIG. 3B, the lock assembly 377 includes a carrier lock 378 and a holder lock 380. The carrier lock 378 selectively clamps the carrier 314 to the device table 308 and the holder lock 380 selectively clamps the device holder 312 to the carrier 314.

In FIG. 3B, the carrier lock 378 includes a vacuum source 382 and one or more fluid inlets 384. The vacuum source 382 creates a vacuum at the fluid inlets 384. When the lifting fluid bearing 364 is not activated, the vacuum pulls the carrier bottom 338 of the carrier 314 against the device table 308 and maintains the carrier 314 against the device table 308. The vacuum source 382 can be turned off when the lifting fluid bearing 364 is activated. Alternately, the vacuum source 382 can be used in conjunction with the lifting fluid bearing 364 to create a vacuum type fluid bearing. The vacuum in the fluid inlets 384 clamps the carrier 314 to the device table 308 to inhibit relative motion between the carrier 314 and the device table 308. The fluid inlets 384 can be in the device table 308 and directed towards the carrier 314 and/or in the carrier 314 and directed towards the device table 308. In FIG. 3B, the fluid inlets 384 are in the carrier recess 342 of the device table 308.

It should be noted that the carrier lock 378 can include another type of mechanism that locks the carrier 314 to the device table 308. The mechanism should preferably be a type that does not generate significant heat near the device holder 312 and is not too heavy.

The holder lock 380 selectively clamps and secures the device holder 312 to the carrier 314 to selectively inhibit rotation and movement of the device holder 312 and the device 300 relative to the device table 308. In FIG. 3A, the holder lock 380 includes the vacuum source 386 and the fluid inlets 388. The vacuum source 382 creates a vacuum at the fluid inlets 388. When activated, the vacuum pulls the device holder 312 against the carrier 314 and locks the device holder 312 to the carrier 314.

The fluid inlets 388 can be in the device holder 312 and directed towards the carrier 314 and/or in the carrier 314 and directed towards the device holder 312. In FIG. 3B, the fluid inlets 388 are in the fluid pads 354.

It should be noted that the holder lock 380 can include another type of mechanism that locking of the device holder 312 to the carrier 314. The mechanism should preferably be a type that does not generate significant heat near the device holder 312 and is not too heavy.

In this embodiment, the device holder 312 is at alternate times (i) kinematically supported relative to the device table 308 and (ii) fixedly clamped to the device table 308. As a result of this design, (i) during calibration of the alignment system, the device holder 312 and the device 300 can be supported kinematically, and (ii) during alignment and exposure processing of wafers, the device holder 312 and the device 300 can be clamped to the device table 308.

In some embodiments, the table assembly 307 can include a holder mover 390 that accurately moves and/or rotates the device holder 312 relative to the device table 308. The design of the holder mover 390 can be varied to suit the design requirements of the rest of the stage assembly.

In FIG. 3B, the holder mover 390 includes a motor and an output wheel. For example, the motor can be a rotary motor that rotates the output wheel. The motor is secured to the device table 308. The output wheel engages a portion, e.g. the outer perimeter the carrier 314.

Additionally, the holder mover can include a motor damper (not shown) that secures the motor to the device table 308. The motor damper inhibits and dampens the reaction forces generated by the motor from being transferred to the device table 308. The motor damper can include a reaction mass assembly, a fluid cylinder, resilient material such as a viscoelastic material, or other type of vibration damping device. Alternately, for example, the motor could be secured directly to the device table 308.

Still alternately, other types of holder movers 390 can be utilized to move and/or rotate the device holder 312 relative to the device table 308. For example, the motor could be secured to the stage or to the apparatus frame. Alternately, the table assembly 307 could include a stop (not shown) that selectively retains a point of the device holder 312. In this embodiment, with the stop inhibiting a point of the device holder 312 from moving, the stage mover assembly 204 moves the device table 308 in a semicircular pattern and the device holder 312 is rotated between the positions about the stop and about the holder axis of rotation. In another embodiment, a center of gravity of the device holder 312 and/or the carrier 314 is offset and positioned away from the holder axis of rotation. With this configuration, the stage mover assembly can be used to accelerate the device table 308 and rotate the device holder 312. Further, in this embodiment, the stage mover assembly can be used to accelerate the device table 308 and stop rotation of the device holder 312.

In yet another embodiment, the motor includes a first component (not shown) and an adjacent second component (not shown) that interacts with the first component. One of the components includes one or more magnet arrays and the other component includes one or more conductor arrays. For the motor, electrical current supplied to the conductor array interacts with a magnetic field generated by the magnet array. This causes a force (Lorentz type force) between the conductor array and the magnet array that can be used to move the device holder relative to the device table between the positions. As provided herein, the second component is secured to the carrier 314 and/or the device holder 312. Further, the first component is secured to a somewhat rigid structure, such as the apparatus frame, the device table, or the stage.

It should be noted that the invention can be used to minimize deformation of the device holder 312 and the device 300 even if rotation is not required. Further, the table assembly 307 could be designed without the carrier 314. In this design, the holder connector assembly 316 would extend directly between the device holder 312 and the device table 308.

FIG. 3C illustrates a perspective view of one of the first flexures 320. The other first flexures 320 can have the same design as the one illustrated or an alternate design. In this embodiment, the first flexure 320 is generally rectangular shaped, and includes a first end 354C, an opposed second end 356C and a flexure longitudinal axis 358C. The first flexure 320 includes a first groove 360C located near the first end 354C that defines a first narrow section 362C, and a second groove 364C located near the second end 356C that defines a second narrow section 366C. In FIG. 3C, each groove 360C, 364C is somewhat annular shaped. The grooves 360C, 364C cooperate to divide the first flexure 320 into a rectangular shaped first stiff section 346, a rectangular shaped intermediate stiff section 368C, and a rectangular shaped second stiff section 350. Further, the first narrow section 362C connects the first stiff section 346 to the intermediate stiff section 368C and the second narrow section 366C connects the intermediate stiff section 368C to the second stiff section 350.

The first flexure 320 has a flexure length 370C that is greater than a flexure thickness 372C. As provided herein, the first flexure 320 can have a flexure length 370C that is at least approximately 2, 5, 10, 20, or 25 greater than the flexure thickness 372C.

With this design, the first flexure 320 is relatively stiff in tension or compression along the flexure axis 358C, and very flexible in bending relative to the flexure axis 358C. Stated another way, the first flexure 320 is relatively stiff in one degree of freedom, and flexible in the other five degrees of freedom. More specifically, each first flexure 320 can have a relatively high stiffness ratio between the stiffness along one axis, versus the other axes. The ratio of relatively high stiffness to relatively low stiffness is preferably at least approximately 100/1, and can be at least approximately 1000/1.

The length and rigidity of the stiff sections 346, 350, 368C and the length and resiliency of the flexible, narrow sections 362C, 366C can be varied to adjust the overall stiffness of each first flexure 320. In FIG. 3E, the length of the intermediate stiff section 368C is significantly longer than the length of each flexible, narrow section 362C, 366C.

FIG. 4 illustrates a perspective view of a portion of another embodiment of a second assembly 422 having features of the present invention. More specifically, FIG. 4 illustrates a perspective view of a second flexure 424 having features of the present invention. The second flexure 424 can be used with two other second flexures. In this embodiment, the second assembly 422 includes three spaced apart second flexures 424 that extend between the device holder 312 (illustrated in FIG. 3B) and the carrier 314 (illustrated in FIG. 3B).

The other second flexures can have the same design as the second flexure 424 illustrated in FIG. 4 or an alternate design. In FIG. 4, the second flexure 424 is generally rectangular shaped, and includes a first end 426, an opposed second end 428 and a flexure longitudinal axis 430. The second flexure 424 includes a first groove 432 located near the first end 426 that defines a first narrow section 434, and a second groove 436 located near the second end 428 that defines a second narrow section 438. In FIG. 4, each groove 432, 436 is somewhat annular shaped. The grooves 432, 436 cooperate to divide the second flexure 424 into a rectangular shaped first stiff section 440, a rectangular shaped intermediate stiff section 442, and a rectangular shaped second stiff section 444. Further, the first narrow section 434 connects the first stiff section 440 to the intermediate stiff section 442 and the second narrow section 438 connects the intermediate stiff section 442 to the second stiff section 444.

The second flexure 424 has a flexure length 446 that is greater than a flexure thickness 448. As provided herein, the second flexure 424 can have a flexure length 446 that is at least approximately 1, 2, 3, 5, or 10 greater than the flexure thickness 448. Further, the flexure length 446 is only approximately 10, 15, 20, 25 or 50 percent of the flexure length 370C of the first flexure 320 (illustrated in FIG. 3C). Stated another way, the flexure length 370C of the first flexure 320 is at least approximately 2, 3, 5, or 10 times longer than the flexure length 446.

With this design, the second flexure 424 is relatively stiff in tension or compression along the flexure axis 430, and relatively flexible in bending relative to the flexure axis 430. Stated another way, the second flexure 424 is relatively stiff in one degrees of freedom, and flexible in the other five degrees of freedom. More specifically, each second flexure 424 can have a relatively high stiffness ratio between the stiffness along one axis, versus the other axes. The ratio of relatively high stiffness to relatively low stiffness is preferably at least approximately 10/1, and can be at least approximately 1000/1.

The length and rigidity of each stiff section 440, 442, 444 and the length and resiliency of the flexible, narrow sections 434, 438 can be varied to adjust the overall stiffness of each second flexure 422.

FIG. 5 illustrates a perspective view of another embodiment of a second flexure 524 that can be used in the table assembly 307 of FIG. 3B. The second flexure 524 is somewhat similar to the second flexure 424 described above and illustrated in FIG. 4. However, in this embodiment, the second flexure 524 is generally flat plate shaped.

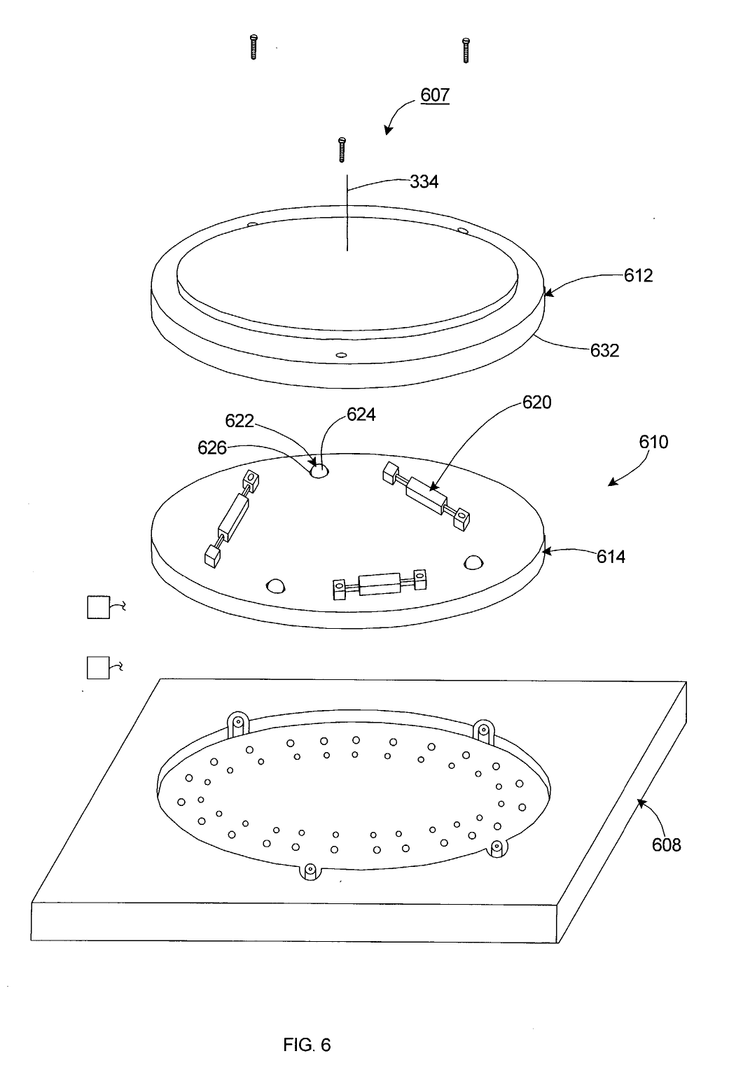

It should be noted that other embodiments of the first assembly and second assembly are possible. More specifically, the flexures can be replaced with another type of kinematic support. For example, FIG. 6 is an exploded perspective view of another embodiment of a table assembly 607 including a device table 608, and a holder assembly 610 including a device holder 612, a carrier 614, and a first assembly 620 that are similar to the corresponding components described above and illustrated in FIG. 3B. However, in this embodiment, the second assembly 622 is different in design.

In FIG. 6, the second assembly 622 includes three spaced apart protrusions 624 that cooperate to support the device holder 612 to the carrier 614 along the Z axis, about the X axis and about the Y axis. In FIG. 6, each of the protrusions 624 is substantially spherical shaped and fits into a connector receiver 626. Each connector receiver 626 can be in the device holder 612 or the carrier 614. In FIG. 6, the connector receiver 626 is in the carrier 614, and each protrusion 624 contracts the flat holder bottom 632 of the device holder 612. At each contact point, there is exactly one constraint. Because there are three protrusions 624, the protrusions 624 provide a total of three degrees of constraint.

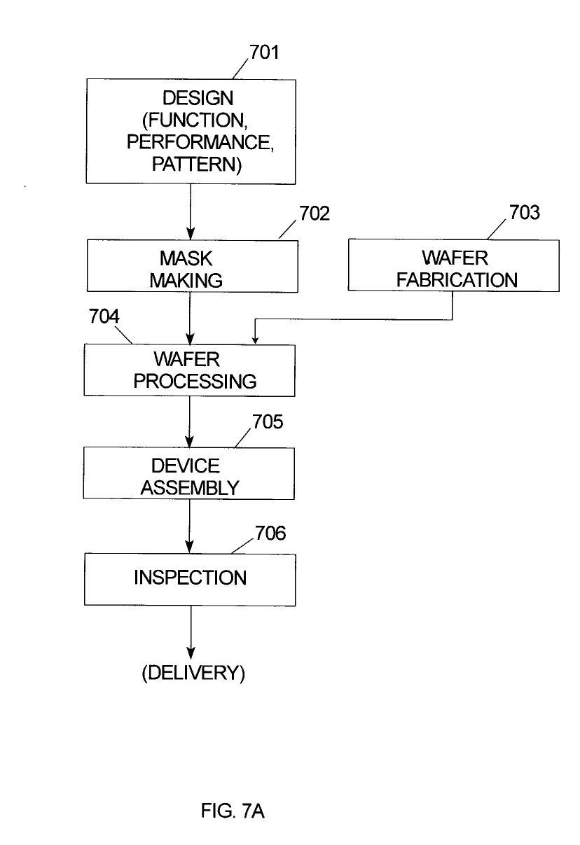

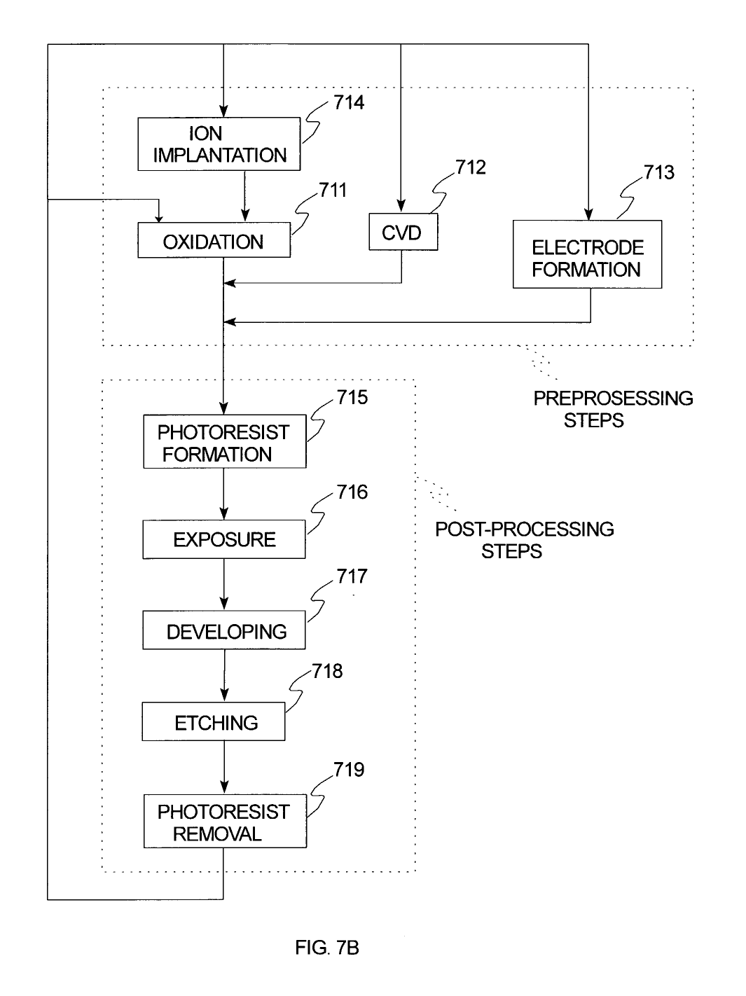

Semiconductor devices can be fabricated using the above described systems, by the process shown generally in FIG. 7A. In step 701 the device's function and performance characteristics are designed. Next, in step 702, a mask (reticle) having a pattern is designed according to the previous designing step, and in a parallel step 703 a wafer is made from a silicon material. The mask pattern designed in step 702 is exposed onto the wafer from step 703 in step 704 by a photolithography system described hereinabove in accordance with the present invention. In step 705 the semiconductor device is assembled (including the dicing process, bonding process and packaging process), finally, the device is then inspected in step 706.

FIG. 7B illustrates a detailed flowchart example of the above-mentioned step 704 in the case of fabricating semiconductor devices. In FIG. 7B, in step 711 (oxidation step), the wafer surface is oxidized. In step 712 (CVD step), an insulation film is formed on the wafer surface. In step 713 (electrode formation step), electrodes are formed on the wafer by vapor deposition. In step 714 (ion implantation step), ions are implanted in the wafer. The above mentioned steps 711-714 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 715 (photoresist formation step), photoresist is applied to a wafer. Next, in step 716 (exposure step), the above-mentioned exposure device is used to transfer the circuit pattern of a mask (reticle) to a wafer. Then in step 717 (developing step), the exposed wafer is developed, and in step 718 (etching step), parts other than residual photoresist (exposed material surface) are removed by etching. In step 719 (photoresist removal step), unnecessary photoresist remaining after etching is removed.

Multiple circuit patterns are formed by repetition of these preprocessing and post-processing steps.

While the particular stage assembly 24 as shown and disclosed herein is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A stage assembly for positioning a device, the stage assembly comprising:
a device table;
a device holder that retains the device; and
a holder connector assembly including a first assembly that supports the device holder relative to the device table along a first axis, and a second assembly that supports the device holder relative to the device table along a second axis, the second axis being orthogonal to the first axis.

2. The stage assembly of claim 1 wherein the holder connector assembly substantially kinematically supports the device holder.

3. The stage assembly of claim 1 wherein the first assembly supports the device holder relative to the device table along a third axis that is orthogonal to the first axis.

4. The stage assembly of claim 3 wherein the first assembly supports the device holder about the second axis and the second assembly supports the device holder about the first axis and about the third axis.

5. The stage assembly of claim 1 wherein the stiffness of the first assembly is greater than the stiffness of the second assembly.

6. The stage assembly of claim 1 wherein the stiffness of the first assembly is at least approximately two times greater than the stiffness of the second assembly.

7. The stage assembly of claim 1 wherein the stiffness of the first assembly is at least approximately ten times greater than the stiffness of the second assembly.

8. The stage assembly of claim 1 wherein the first assembly includes three spaced apart first flexures.

9. The stage assembly of claim 8 wherein the second assembly includes three spaced apart second flexures.

10. The stage assembly of claim 9 wherein at least one of the first flexures is longer than the second flexures.

11. The stage assembly of claim 9 wherein at least one of the first flexures is at least approximately two times longer than the second flexures.

12. The stage assembly of claim 9 wherein at least one of the first flexures is at least approximately ten times longer than the second flexures.

13. The stage assembly of claim 8 wherein the second assembly includes a plurality of spaced apart, fluid bearing.

14. The stage assembly of claim 8 wherein the second assembly includes a plurality of spaced apart protrusions.

15. The stage assembly of claim 1 wherein the device holder rotates relative to the device table.

16. The stage assembly of claim 1 further comprising a carrier, wherein the holder connector assembly flexibly connects the device holder to the carrier.

17. The stage assembly of claim 16 wherein the carrier and the device holder rotate relative to the device table.

18. The stage assembly of claim 1 further comprising a stage mover assembly that moves the device table.

19. An exposure apparatus including the stage assembly of claim 1.

20. A device manufactured with the exposure apparatus according to claim 19.

21. A wafer on which an image has been formed by the exposure apparatus of claim 19.

22. A stage assembly for positioning a device, the stage assembly comprising:
a device table;
a carrier that is connected to the device table;
a device holder that retains the device; and
a holder connector assembly including a first assembly that connects the device holder to the carrier along a first axis and along a third axis that is orthogonal to the first axis, and a second assembly that connects the device holder to the carrier along a second axis, the second axis being orthogonal to the first axis and the third axis, the first assembly and the second assembly cooperating to substantially kinematically support the device holder.

23. The stage assembly of claim 22 wherein the first assembly supports the device holder about the second axis and the second assembly supports the device holder about the first axis and about the third axis.

24. The stage assembly of claim 22 wherein the stiffness of the first assembly is greater than the stiffness of the second assembly.

25. The stage assembly of claim 22 wherein the stiffness of the first assembly is at least approximately two times greater than the stiffness of the second assembly.

26. The stage assembly of claim 22 wherein the stiffness of the first assembly is at least approximately ten times greater than the stiffness of the second assembly.

27. The stage assembly of claim 22 wherein the first assembly includes three spaced apart first flexures.

28. The stage assembly of claim 27 wherein the second assembly includes three spaced apart second flexures.

29. The stage assembly of claim 27 wherein the second assembly includes three spaced apart, fluid bearing.

30. The stage assembly of claim 27 wherein the second assembly includes three spaced apart protrusions.

31. The stage assembly of claim 22 wherein the device holder rotates relative to the device table.

32. The stage assembly of claim 22 further comprising a carrier, wherein the holder connector assembly flexibly connects the device holder to the carrier.

33. The stage assembly of claim 32 wherein the carrier and the device holder move relative to the device table.

34. The stage assembly of claim 22 further comprising a stage mover assembly that moves the device table.

35. An exposure apparatus including the stage assembly of claim 22.

36. A device manufactured with the exposure apparatus according to claim 35.

37. A wafer on which an image has been formed by the exposure apparatus of claim 35.

38. A method for making a stage assembly that holds a device, the method comprising the steps of:
providing a device table that is supported movably; and
securing a device holder that retains the device to the device table along a first axis with a first assembly, and along a second axis with a second assembly, the second axis being orthogonal to the first axis.

39. The method of claim 38 wherein the step of securing includes substantially kinematically securing the device holder to the device table.

40. The method of claim 38 wherein the first assembly supports the device holder relative to the device table along a third axis that is orthogonal to the first axis.

41. The method of claim 38 wherein the first assembly supports the device holder about the second axis and the second assembly supports the device holder about the first axis and about the third axis.

42. The method of claim 38 wherein the stiffness of the first assembly is greater than the stiffness of the second assembly.

43. The method of claim 38 wherein the first assembly includes three spaced apart first flexures.

44. The method of claim 43 wherein the second assembly includes three spaced apart second flexures.

45. The method of claim 43 wherein the second assembly includes three spaced apart, fluid bearings.

46. The method of claim 43 wherein the second assembly includes three spaced apart protrusions.

47. The method of claim 38 further comprising the step of providing a carrier, wherein the first assembly and the second assembly connect the device holder to the carrier.

48. The method of claim 38 further comprising the step of rotating the device holder relative to the device table.

49. A method for making an exposure apparatus that forms an image on an object, the method comprising the steps of:
providing an irradiation apparatus that irradiates the object with radiation to form the image on the object; and
providing the stage assembly made by the method of claim 38.

50. A method of making a wafer utilizing the exposure apparatus made by the method of claim 49.

51. A method of making a device including at least the exposure process: wherein the exposure process utilizes the exposure apparatus made by the method of claim 49.
